(19) United States
(12) Patent Application Publication
(10) Pub. No.: US 2016/0055615 A1
(43) Pub. Date: Feb. 25, 2016

(54) Smart Frequency Boost For Graphics-Processing Hardware

(71) Applicant: MediaTek Inc., Hsinchu (TW)

(72) Inventor: Po-hua Huang, Hsinchu (TW)

(21) Appl. No.: 14/932,486

(22) Filed: Nov. 4, 2015

Related U.S. Application Data
(60) Provisional application No. 62/077,985, filed on Nov. 11, 2014.

(51) Int. Cl. G06T 1/20

(52) U.S. Cl. CPC G06T 1/20

(57) ABSTRACT

A technique, as well as select implementations thereof, pertaining to smart frequency boost for graphics-processing hardware is described. A method may involve monitoring a queue of a plurality of graphics-related processes pending to be executed by a graphics-processing hardware to determine whether one or more predetermined conditions of the graphics-related processes in the queue are met. The one or more predetermined conditions may include an accumulation condition of the graphics-related processes in the queue. The method may also involve dynamically adjusting at least one operating parameter of the graphics-processing hardware in response to a determination that each of the one or more predetermined conditions of the graphics-related processes in the queue is met.

### CROSS REFERENCE TO RELATED PATENT APPLICATION

The present disclosure claims the priority benefit of U.S. Provisional Patent Application No. 62/077,985, filed on 11 Nov. 2014, which is incorporated by reference in its entirety.

### TECHNICAL FIELD

The present disclosure is generally related to voltage and frequency scaling and, more particularly, to smart frequency boost for graphics-processing hardware.

### BACKGROUND

Unless otherwise indicated herein, approaches described in this section are not prior art to the claims listed below and are not admitted to be prior art by inclusion in this section.

Portable electronic apparatuses such as smartphones and tablet computers are typically equipped with multiple functions and features. In general, multiple power sources are provided in a portable electronic apparatus to power the multiple functions and features, and these multiple functions and features are typically controlled individually regarding their respective power supply and usage.

Dynamic voltage and frequency scaling (DVFS), a power management technique, is typically employed in portable electronic apparatuses for system power saving. In conventional approaches, runtime software for DVFS may be utilized to adjust the voltage and/or frequency (herein interchangeably referred to as clock rate), according to system requirements of the portable electronic apparatus. However, the software needs to synchronize with current system requirements for voltage and clock rate according to scenario usage in order to determine whether voltage scaling and/or frequency scaling (or clock rate adjustment) would be required. It also takes time for the software to synchronize with the system requirements. Moreover, DVFS by software tends to be coarse-grained as opposed to fine-grained DVFS achievable by hardware (e.g., three-dimensional benchmark in the context of graphics processing). Conventional approaches of DVFS may be sufficient for scenarios with small variation in system loading or easy prediction of loading. However, conventional approaches of DVFS tend to have difficulty in coping with scenarios having large or abrupt variation in system loading or difficult prediction of loading (e.g., rendering of user interface in the context of graphics processing).

### SUMMARY

The following summary is illustrative only and is not intended to be limiting in any way. That is, the following summary is provided to introduce concepts, highlights, benefits and advantages of the novel and non-obvious techniques described herein. Select, not all, implementations are further described below in the detailed description. Thus, the following summary is not intended to identify essential features of the claimed subject matter, nor is it intended for use in determining the scope of the claimed subject matter.

In one example implementation, a method may involve monitoring a queue of a plurality of graphics-related processes pending to be executed by a graphics-processing hardware to determine whether one or more predetermined conditions of the graphics-related processes in the queue are met. The one or more predetermined conditions may include an accumulation condition of the graphics-related processes in the queue. The method may also involve dynamically adjusting at least one operating parameter of the graphics-processing hardware in response to a determination that each of the one or more predetermined conditions of the graphics-related processes in the queue is met.

In another example implementation, a method may involve determining whether a simultaneous execution of two or more graphics-related processes by a graphics-processing hardware is scheduled to begin. The method may also involve setting a lower-bound frequency of the graphics-processing hardware in response to one or more determinations, which may include a determination that the simultaneous execution of an accumulated number of the two or more graphics-related processes by the graphics-processing hardware is scheduled to begin. The accumulated number may be equal to or greater than a predetermined number. The method may further involve adjusting a voltage, an operating frequency, or both, of the graphics-processing hardware according to varying process demands. The lower-bound frequency may be a lower bound for possible operating frequencies at which the graphics-processing hardware operates as a result of the adjusting. The one or more determinations may also include a determination that the simultaneous execution of the graphics-related processes by the graphics-processing hardware indicates a predicted loading greater than a threshold.

In yet another example implementation, an apparatus may include a graphics-processing hardware and a control logic. The graphics-processing hardware may be configured to execute one or more graphics-related processes. The control logic may be configured to monitor a queue of a plurality of graphics-related processes pending for execution by the graphics-processing hardware. The control logic may be also configured to determine whether one or more predetermined conditions of the graphics-related processes in the queue are met based on the monitoring. The one or more predetermined conditions may include an accumulation condition of the graphics-related processes in the queue. The control logic may be further configured to dynamically adjust at least one operating parameter of the graphics-processing hardware in response to a determination that each of the one or more predetermined conditions of the graphics-related processes in the queue is met. The one or more predetermined conditions may also include an overloading condition.

Accordingly, implementations in accordance with the present disclosure may proactively monitor a queue of graphics-related processes pending to be executed by a graphics-processing hardware, and dynamically adjust one or more operating parameters of the graphics-processing hardware correspondingly. For instance, the lower bound of possible operating frequencies at which the graphics-processing hardware operates may be raised when the number of processes pending in the queue reaches a threshold. Advantageously, implementations in accordance with the present disclosure can improve performance of the graphics-processing hardware, at least to a certain extent, in handling scenarios with large variation in system loading or difficult prediction of loading.

Moreover, it is noteworthy that, although examples and select implementations described herein are primarily in the context of graphics processing and video playback, the proposed techniques of the present disclosure may be also implementable in applications other than graphics processing or video playback. In other words, scope of the present disclosure is not limited to what is described herein.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example framework of DVFS with smart frequency boost in accordance with an implementation of the present disclosure.

FIG. 2 is a diagram of an example implementation in the context of graphics processing in accordance with the present disclosure.

FIG. 3 is a diagram of an example scenario in the context of DVFS with smart frequency boost for a graphics-processing hardware in accordance with an implementation of the present disclosure.

FIG. 4 is a diagram of an example implementation in the context of video playback in accordance with the present disclosure.

FIG. 5 is a diagram of an example algorithm in accordance with an implementation of the present disclosure.

FIG. 6 is a block diagram of an example apparatus in accordance with an implementations of the present disclosure.

FIG. 7 is a flowchart of an example process in accordance with an implementation of the present disclosure.

FIG. 8 is a flowchart of an example process in accordance with another implementation of the present disclosure.

FIG. 9 is a diagram of a conventional approach of DVFS.

### DETAILED DESCRIPTION OF PREFERRED EMBODIMENTS

### Overview

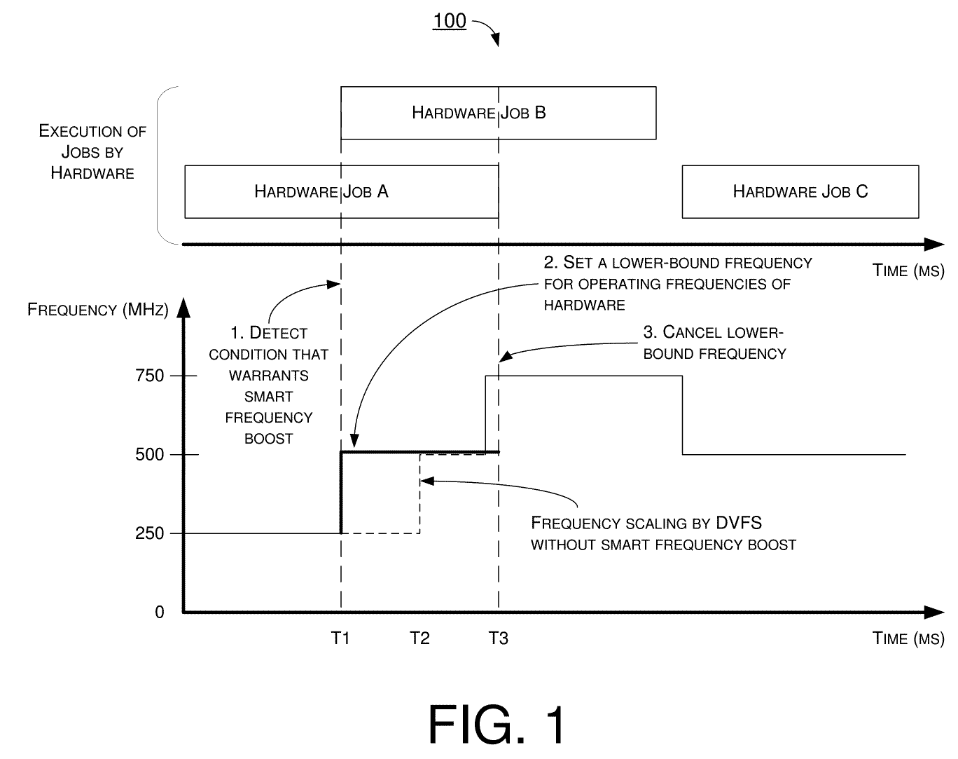

FIG. 1 illustrates an example framework 100 of DVFS with smart frequency boost in accordance with an implementation of the present disclosure. As shown in FIG. 1, a timing diagram of frequency versus time indicates changes in the operating frequency of a hardware component in time as a result of DVFS. At any given time the hardware component operates at a particular operating frequency among multiple possible operating frequencies at which the hardware component can operate. Under DVFS, the hardware component can operate at a higher frequency when system requirement or loading is relatively high and, conversely, the hardware component can operate at a lower frequency when system requirement or loading is relatively low. In framework 100 a number of jobs (e.g., processes, computations, permutations and/or operations) are queued up in a queue awaiting to be executed by the hardware component and, at any given time, the hardware component may be executing one job, more than one job, or no job. The hardware component may be one or more processor(s)/processing unit(s) such as, for example, a graphics-processing unit (GPU), a video decoder and/or an application-specific integrated circuit (ASIC).

According to the present disclosure, a control logic may monitor the queue of jobs to detect whether an accumulation condition regarding the jobs in the queue is met, initiate smart frequency boost when the accumulation condition is met, and stop smart frequency boost when the accumulation condition no longer exists. For instance, an accumulation condition regarding the jobs in the queue may be a condition in which it is detected that a threshold or predetermined number (e.g., 2, 3, 4 or a larger number) of jobs are queued up or otherwise scheduled to be simultaneously executed by the hardware component sometime in the near future. Once such condition is detected or otherwise determined, the control logic may initiate smart frequency boost at the time when the predetermined number of jobs are to be simultaneously executed by the hardware component, and then stop smart frequency boost when such condition no longer exists (e.g., the number of jobs simultaneously executed by the hardware component falls below the predetermined number). The control logic may be implemented in the form of software, firmware, middleware, hardware or any combination thereof.

In framework 100, a number of hardware jobs are queued up for execution by the hardware component, including hardware job A, hardware job B and hardware job C. The control logic may detect that for a certain period of time both hardware job A and hardware job B are scheduled to be simultaneously executed by the hardware component. Assuming the predetermined number is two, the control logic may initiate smart frequency boost for the hardware component by setting a lower-bound frequency such that the available operating frequencies at which hardware component can operate are limited to be no lower than the lower-bound frequency when smart frequency boost is in effect. As shown in FIG. 1, without the smart frequency boost in accordance with the present disclosure, there would be a time delay for conventional DVFS to increase the operating frequency of the hardware component (e.g., from 250 MHz to 500 MHz) some amount of after the hardware component has begun to simultaneously execute both hardware job A and hardware job B. With smart frequency boost, however, the control logic may dynamically adjust the frequency by setting the lower-bound frequency so that, as a result, DVFS may increase the actual operating frequency of the hardware component to 500 MHz (or higher) sooner than it would have without smart frequency boost.

In the example shown in FIG. 1, upon detecting that hardware job A and hardware job B are scheduled to be simultaneously executed by the hardware component beginning at time T1, the control logic may set the lower-bound frequency to be 500 MHz and to be in effect beginning at time T1. This means the hardware component can operate at an operating frequency that is equal to or greater than 500 MHz beginning at time T1. In other words, although the hardware component may be configured to operate at 250 MHz, 500 MHz or 750 MHz at any given time during operation, when the lower-bound frequency is set to 500 MHz the hardware component can only operate at either 500 MHz or 750 MHz but not 250 MHz. Accordingly, the hardware component may operate at 250 MHz when executing hardware job A alone and then operate at 500 MHz or 750 MHz beginning at time T1 when the hardware component begins to simultaneously execute both hardware job A and hardware job B. Without such feature of smart frequency boost, conventional DVFS might not increase the operating frequency of the hardware component from 250 MHz to 500 MHz until time T2. Moreover, the control logic may also detect that the simultaneous execution of both hardware job A and hardware job B is to end at time T3 due to the completion of execution of hardware job A at such time. Accordingly, the control logic may nullify or otherwise cancel the lower-bound frequency beginning at time T3. In other words, the lower-bound frequency can be set from 500 MHz back to 250 MHz. This means the hardware component can operate at any operating frequency among all possible operating frequencies at which the hardware component is configured to operate (e.g., 250 MHz, 500 MHz and 750 MHz), including ones that are lower than the current lower-bound frequency of 500 MHz.

Thus, rather than replacing DVFS, the smart frequency boost in accordance with the present disclosure supplements DVFS in that smart frequency boost remedies the issue with the time delay increasing the operating frequency of the hardware component in time to handle large variation in system loading or difficult prediction of loading. In some implementations, the value of the lower-bound frequency may be a variable and dynamically adjusted by the control logic according to the accumulation condition. That is, the control logic may set the lower-bound frequency appropriately depending on how many hardware jobs in a queue are scheduled for simultaneous execution by the hardware component. In other words, in some implementations the value of the lower-bound frequency may be varying over time and not fixed at a certain value. For instance and not limiting the scope of the present disclosure, when the control logic detects that there will be two hardware jobs simultaneously executed by the hardware component the control logic may set the lower-bound frequency to 500 MHz. Later, when the control logic detects that there will be three or four hardware jobs simultaneously executed by the hardware component the control logic may set the lower-bound frequency to 750 MHz. Subsequently, when the control logic detects that there will be two hardware jobs simultaneously executed by the hardware component the control logic may set the lower-bound frequency back to 500 MHz.

Alternatively, the value of the lower-bound frequency may be a fixed value when smart frequency boost is in effect regardless of the number of hardware jobs to be simultaneously executed by the hardware component. For instance and not limiting the scope of the present disclosure, the control logic may set the lower-bound frequency to 750 MHz upon detection of two or more hardware jobs scheduled to be simultaneously executed by the hardware component regardless of how many hardware jobs are accumulated. In some implementations, the control logic may nullify or otherwise cancel the lower-bound frequency beginning at a time when the hardware component is scheduled to execute no job or one job.

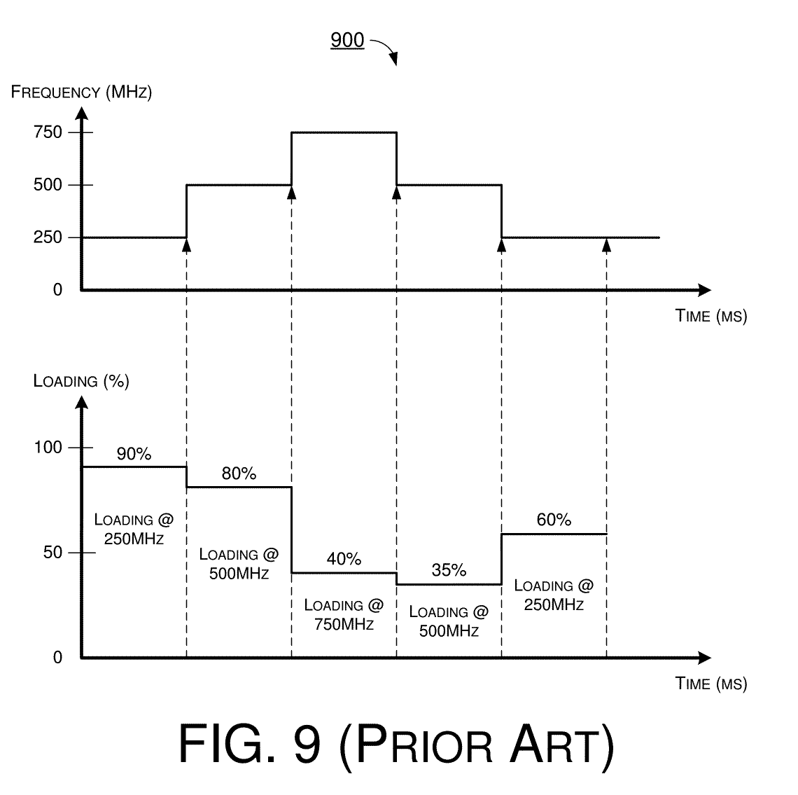

In contrast, FIG. 9 illustrates a conventional approach 900 of DVFS without the smart frequency boost feature in accordance with the present disclosure. In approach 900, the DVFS policy may include the following: (1) increase operating frequency if hardware loading is greater than or equal to 75%, and (2) decrease operating frequency if hardware loading is less than 50%. Thus, under approach 900, DVFS may be carried out by performing a number of operations as follows: (1) calculate the current hardware loading, (2) predict the loading trend, and (3) change the operating frequency for the next time slot. Accordingly, as shown in FIG. 9, the hardware operating frequency may be at 250 MHz when hardware loading may be at 90%, and DVFS may increase the operating frequency to 500 MHz for the next time slot during which the hardware loading may be at 80%. DVFS may further increase the operating frequency to 750 MHz for the following time slot during which the hardware loading may fall to 40%. DVFS may then decrease the operating frequency to 500 MHz for the next time slot during which the hardware loading may be at 35%. DVFS may correspondingly further decrease the operating frequency to 250 MHz for the next time slot during which the hardware loading may jump up to 60%. As can be seen, conventional approach of DVFS may not be able to cope with scenarios in which there is large or abrupt variation in hardware loading or when it is difficult to predict changes in hardware loading.

It is noted that although in the described example only an accumulation condition is used to determine whether or not to activate the smart frequency boost, the present disclosure is not limited thereto. In other words, implementations of the present disclosure also include the determination of whether each of one or more predetermined conditions of the graphics-related processes in the queue is met or not. When each of the one or more predetermined conditions is met, the smart frequency boost can be activated. In some implementations, the one or more predetermined conditions may include the accumulation condition. In some other implementations, the one or more predetermined conditions may include the accumulation condition and an overloading condition. For instance, the overloading condition may be an overloading condition of the job in the queue in which the graphics-related processes or jobs in the queue that the graphics-processing hardware is scheduled to simultaneously execute indicate a predicted loading greater than a threshold (e.g., an upper limit of loading for the graphics-processing hardware). The loading of the graphics-related processes or jobs can be predicted, for example, according to historical data such as historical loading of the graphics-processing hardware. In a specific example, when a number of jobs scheduled to begin is determined to be accumulated (e.g., two or more jobs), whether the jobs cause a high loading can be further determined. According to a prediction made using historical data, when the types of the jobs indicate a predicted loading greater than the threshold, smart frequency boost in accordance with the present disclosure may be activated. Conversely, when the types of the jobs indicate a predicted loading not greater than the threshold, smart frequency boost may be deactivated.

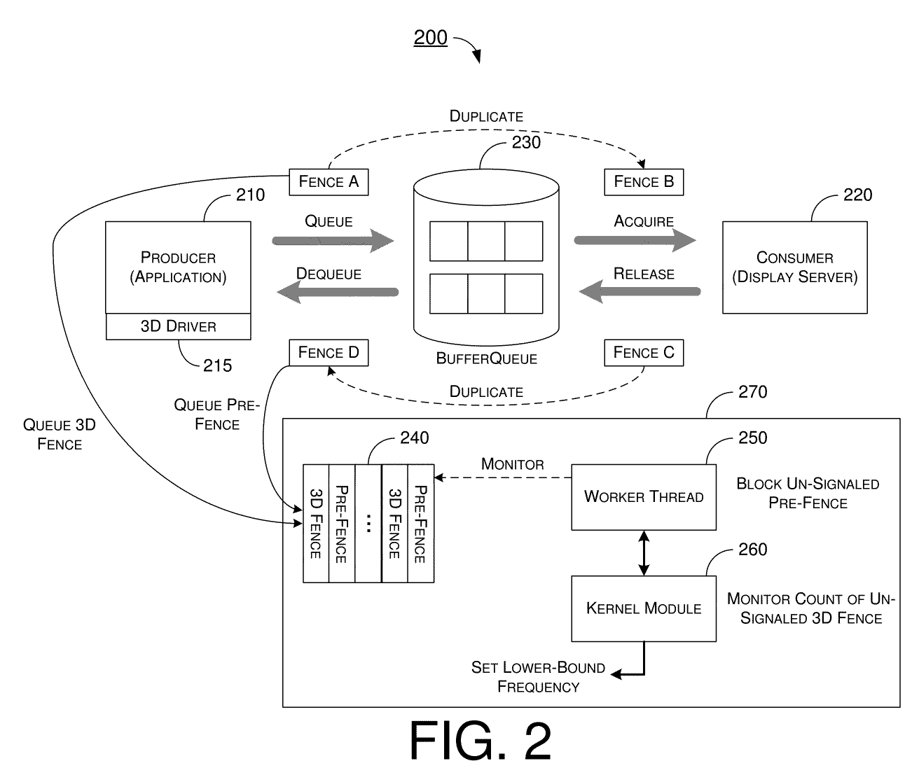

FIG. 2 illustrates an example implementation 200 in the context of graphics processing in accordance with the present disclosure. Implementation 200 may reflect an implementation of techniques of the present disclosure in a GPU. Thus, components shown in FIG. 2 may be hardware and/or software components in or executable by a GPU. Implementation 200 may involve a producer 210, a consumer 220 and a BufferQueue 230. BufferQueue 230 may function as a medium between producer 210 and consumer 220 in that producer 210 may write data into BufferQueue 230, from which consumer 220 may read such data. In the context of graphics processing, producer 210 may be an application and consumer 220 may be a display server, for example. BufferQueue 230 may be a circular buffer. Producer 210 may include a three-dimensional (3D) driver 215.

Referring to FIG. 2, producer 210 may prepare a number of fences that are for example 3D fences such as fence A and fence B. The 3D fences may be generated by 3D driver 215. Producer 210 may queue up these 3D fences by writing them into BufferQueue 230, and consumer 220 may acquire the 3D fences by reading them from BufferQueue 230. Similarly, consumer 220 may release a number of fences that are pre-fences such as fence C and fence D. Consumer 220 may release these pre-fences by writing them into BufferQueue 230, and producer 210 may dequeue the pre-fences by reading them from BufferQueue 230. In the example shown in FIG. 2, fence B may be a duplicate of fence A, and fence D may be a duplicate of fence C. A given 3D fence (e.g., fence A) queued by producer 210 may be either un-signaled or signaled. For instance, a 3D fence is un-signaled before GPU finishes writing one buffer in BufferQueue 230 (for rendering a frame corresponding to the 3D fence), and the 3D fence is signaled after the GPU has finished writing the buffer in BufferQueue 230. An un-signaled 3D fence indicates a frame awaiting to be rendered, and a signaled 3D fence indicates the rendering of the frame is complete. In other words, the rendering of a frame may constitute a job described above. Similarly, a given pre-fence (e.g., fence C) released by consumer 220 may be either un-signaled or signaled. For instance, a pre-fence is un-signaled when consumer 220 is reading one buffer in BufferQueue 230 (for displaying a frame corresponding to the pre-fence), and the pre-fence is signaled after consumer 220 has finished reading the buffer in BufferQueue 230. An un-signaled pre-fence indicates a frame awaiting to be displayed, and a signaled pre-fence indicates displaying of the job is complete.

Implementation 200 may also involve a control logic 270 in accordance with the present disclosure. Control logic 270 may include a queue buffer 240, a worker thread 250 and a kernel module 260. Components of control logic 270 may be implemented in the form of software, firmware, middleware, hardware or any combination thereof. As an example, queue buffer 240 may be implemented in the form of hardware (e.g., cache memory) capable of storing a series or queue of fences including 3D fences and pre-fences reflective of the 3D fences (e.g., fence A) queued by producer 210 and the pre-fences (e.g., fence D) dequeued by producer 210. As another example, each of worker thread 250 and kernel module 260 may be implemented in the form of software modules and may be executed by a GPU driver.

In operation, queue buffer 240 may store a fence queue of pre-fences and 3D fences that are queued and dequeued by producer 210. Each of the pre-fences and 3D fences in queue buffer 240 may be either un-signaled or signaled. Worker thread 250 may monitor the status of the pre-fences and 3D fences in queue buffer 240. When the status of a current pre-fence in queue buffer 240 is un-signaled, worker thread 250 may wait for the current pre-fence in queue buffer 240 to become signaled. Once the status of the current pre-fence in queue buffer 240 becomes signaled, worker thread 250 may send kernel module 260 the next 3D fence that is in queue buffer 240. Kernel module 260 may then count the number of un-signaled 3D fences sent from worker thread 250. The number of un-signaled 3D fences thus counted by kernel module 260 may indicate the number of buffer writing (e.g., the buffer rendering) awaiting to be simultaneously executed. In an event that the number of un-signaled 3D fences is greater than a predetermined number or threshold (e.g., 2, 3, 4 or a greater number), kernel module 260 may initiate smart frequency boost by setting a lower-bound frequency. Later, when the number of un-signaled 3D fences is no longer greater than the predetermined number, kernel module 260 may stop smart frequency boost by nullifying or otherwise cancelling the lower-bound frequency or setting the lower-bound frequency back to a default value.

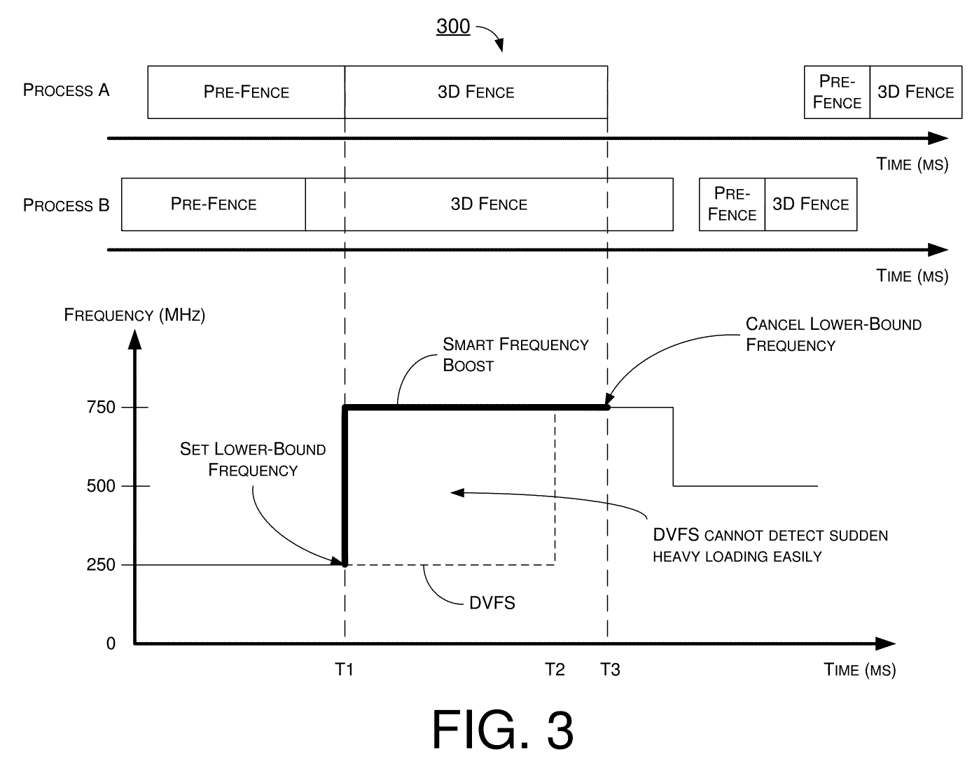

FIG. 3 illustrates an example scenario 300 in the context of DVFS with smart frequency boost for a graphics-processing hardware in accordance with an implementation of the present disclosure. In the example shown in FIG. 3, there are two concurrent processes in a kernel module (e.g., kernel module 260), process A and process B, each of which including a queue of pairs of pre-fence and 3D fence. The kernel module may detect whether there are at least a predetermined number (e.g., 2) of un-signaled 3D fences existing in both process A and process B concurrently. The existence of at least the predetermined number of un-signaled 3D fences in both process A and process B concurrently indicates there are at least the predetermined number of hardware jobs awaiting to be simultaneously executed. Thus, upon detecting at least the predetermined number of un-signaled 3D fences, the kernel module may initiate smart frequency boost by setting a lower-bound frequency. In the example shown in FIG. 3, the lower-bound frequency is set to 750 MHz by the kernel module beginning at time T1, and correspondingly the hardware operating frequency is increased to 750 MHz at time T1. Without smart frequency boost, DVFS would not be able to detect the sudden heavy loading easily and thus may not increase the hardware operating frequency until time T2. Later, at time T3, when the number of un-signaled 3D fences is no longer greater than the predetermined number (e.g., 0 or 1), the kernel module may stop smart frequency boost by nullifying or otherwise cancelling the lower-bound frequency. At such time the operating frequency may be set by DVFS to an appropriate frequency among a number of possible frequencies at which the hardware is configured to operate.

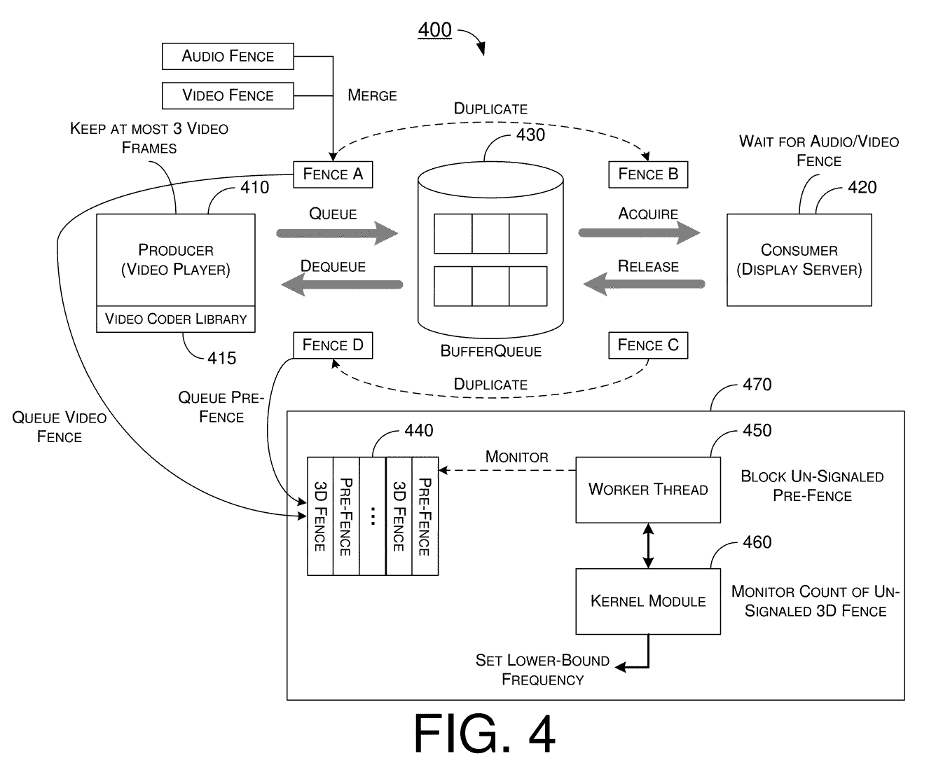

FIG. 4 illustrates an example implementation 400 in the context of video playback in accordance with the present disclosure. Implementation 400 may reflect an implementation of techniques of the present disclosure in a video decoder. Thus, components shown in FIG. 4 may be hardware and/or software components in a video decoder. Implementation 400 may involve a producer 410, a consumer 420 and a BufferQueue 430. BufferQueue 430 may function as a medium between producer 410 and consumer 420 in that producer 410 may write data into BufferQueue 430, from which consumer 420 may read such data. In the context of video playback, producer 410 may be a video player and consumer 420 may be a display server, for example. BufferQueue 430 may be a circular buffer. Producer 410 may include a video coder library 415.

Referring to FIG. 4, producer 410 may prepare a number of fences that are video fences such as fence A and fence B. Producer 410 may queue up these video fences by writing them into BufferQueue 430, and consumer 420 may acquire the video fences by reading them from BufferQueue 430. Similarly, consumer 420 may release a number of fences that are pre-fences such as fence C and fence D. Consumer 420 may release these pre-fences by writing them into BufferQueue 430, and producer 410 may dequeue the pre-fences by reading them from BufferQueue 430. In the example shown in FIG. 4, fence B may be a duplicate of fence A, and fence D may be a duplicate of fence C. A given video fence (e.g., fence A) queued by producer 410 may be either un-signaled or signaled. For instance, a video fence is un-signaled before producer 410 finishes writing one buffer into BufferQueue 430 (for decoding a frame corresponding to the video fence), and the video fence is signaled after producer 410 has finished writing the buffer into BufferQueue 430. An un-signaled video fence indicates a frame awaiting to be decoded, and a signaled video fence indicates decoding of the frame is complete. In other words, the decoding of a frame may constitute a job described above. Similarly, a given pre-fence (e.g., fence C) released by consumer 420 may be either un-signaled or signaled. For instance, a pre-fence is un-signaled before consumer 420 finishes reading one buffer into BufferQueue 430, and the pre-fence is signaled after consumer 420 has finished reading the buffer into BufferQueue 430. An un-signaled pre-fence indicates a buffer awaiting to be displayed, and a signaled pre-fence indicates displaying of the buffer is complete.

Implementation 400 may also involve a control logic 470 in accordance with the present disclosure. Control logic 470 may include a queue buffer 440, a worker thread 450 and a kernel module 460. Components of control logic 470 may be implemented in the form of software, firmware, middleware, hardware or any combination thereof. As an example, queue 440 buffer may be implemented in the form of hardware (e.g., cache memory) capable of storing a series or queue of fences including video fences and pre-fences reflective of the video fences (e.g., fence A) queued by producer 410 and the pre-fences (e.g., fence D) dequeued by producer 410. As another example, each of worker thread 450 and kernel module 460 may be implemented in the form of software modules and may be executed by a decoder driver.

In operation, queue buffer 440 may store a fence queue of pre-fences and video fences that are queued and dequeued by producer 410. Each of the pre-fences and video fences in queue buffer 440 may be either un-signaled or signaled. Worker thread 450 may monitor the status of the pre-fences and video fences in queue buffer 440. When the status of a current pre-fence in queue buffer 440 is un-signaled, worker thread 450 may wait for the current pre-fence in queue buffer 440 to become signaled. Once the status of the current pre-fence in queue buffer 440 becomes signaled, worker thread 450 may send kernel module 460 the next video fence that is in queue buffer 240. Kernel module 460 may then count the number of un-signaled video fences sent from worker thread 450. The number of un-signaled video fences thus counted by kernel module 460 may indicate the number of frames awaiting to be simultaneously decoded. In an event that the number of un-signaled video fences is greater than a predetermined number or threshold (e.g., 2, 3, 4 or a greater number), kernel module 460 may initiate smart frequency boost by setting a lower-bound frequency. Later, when the number of un-signaled video fences is no longer greater than the predetermined number, kernel module 460 may stop smart frequency boost by nullifying or otherwise cancelling the lower-bound frequency or setting the lower-bound frequency back to a default value.

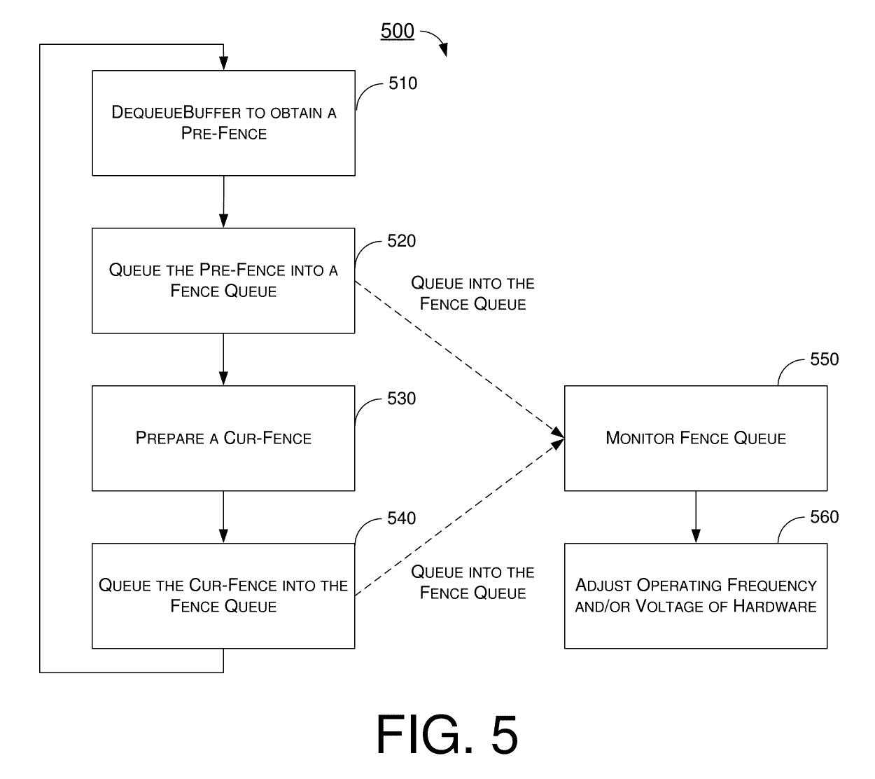

FIG. 5 illustrates an example algorithm 500 pertaining to graphics processing or video playback, although the concept depicted herein may be implemented in other applications. Algorithm 500 may involve one or more operations, actions, or functions as represented by one or more of blocks 510, 520, 530, 540, 550 and 560. Although illustrated as discrete blocks, various blocks of algorithm 500 may be divided into additional blocks, combined into fewer blocks, or eliminated, depending on the desired implementation.

At 510, algorithm 500 may involve performing operation “DequeueBuffer” to obtain a pre-fence. For instance, referring to FIG. 2, producer 210 may dequeue a pre-fence by reading it from BufferQueue 230. Algorithm 500 may proceed from 510 to 520.

At 520, algorithm 500 may involve queueing the pre-fence into a fence queue. For instance, referring to FIG. 2, producer 210 may queue the pre-fence into a fence queue stored in queue buffer 240. Algorithm 500 may proceed from 520 to 530.

At 530, algorithm 500 may involve preparing a current-fence. For instance, referring to FIG. 2, producer 210 may prepare a 3D fence. Algorithm 500 may proceed from 530 to 540.

At 540, algorithm 500 may involve queueing the current-fence into the fence queue. For instance, referring to FIG. 2, producer 210 may queue the 3D fence into the fence queue stored in queue buffer 240. Algorithm 500 may proceed from 540 back to 510.

Furthermore, algorithm 500 may proceed from 520 and 540 to 550.

At 550, algorithm 500 may involve monitoring the fence queue. For instance, referring to FIG. 2, kernel module 260 may monitor the fence queue to detect whether there is at least a predetermined number of un-signaled 3D fences. Algorithm 500 may proceed from 550 to 560.

At 560, algorithm 500 may involve adjusting the operating frequency and/or voltage of hardware. For instance, referring to FIG. 2, upon detecting at least the predetermined number of un-signaled 3D fences, kernel module 260 may set the lower-bound frequency to adjust the operating frequency of the hardware.

### Example Implementations

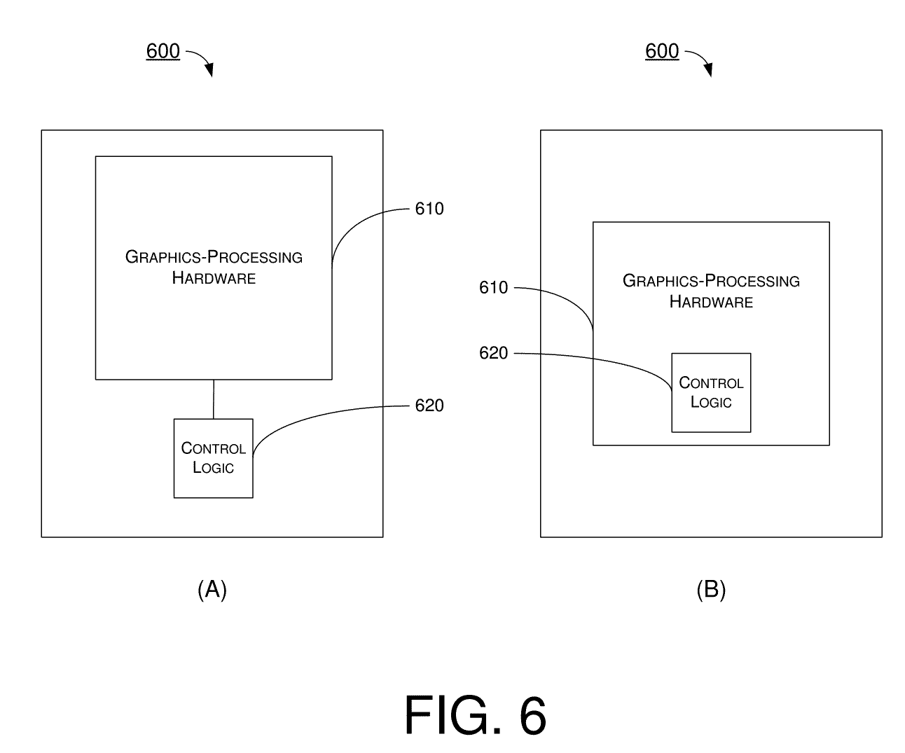

FIG. 6 illustrates an example apparatus 600 in accordance with an implementations of the present disclosure. Apparatus 600 may perform various functions to implement techniques, methods and systems described herein, including framework 100, implementation 200, scenario 300, implementation 400 and algorithm 500 described above as well as processes 700 and 800 described below. In some implementations, apparatus 600 may be a portable electronic apparatus such as, for example, a smartphone, a computing device such as a tablet computer, a laptop computer, a notebook computer, or a wearable device. In some implementations, apparatus 600 may be a GPU or a video decoder, and may be in the form of a single IC chip, multiple IC chips or a chipset.

Apparatus 600 may include at least those components shown in FIG. 6, such as a graphics-processing hardware 610 and a control logic 620. Part (A) of FIG. 6 shows one implementation of apparatus 600 in which control logic 620 is separate from graphics-processing hardware 620. For instance, each of graphics-processing hardware 610 and control logic 620 may be implemented in a respective IC chip. Part (B) of FIG. 6 shows another implementation of apparatus 600 in which control logic 620 is an integral part of graphics-processing hardware 610. For instance, graphics-processing hardware 610 may be implemented in a single IC chip with a certain portion of the IC chip designed, dedicated or otherwise configured to implement the functionality of control logic 620.

Graphics-processing hardware 610 may be configured to execute one or more graphics-related processes such as, for example, in manners similar to those described above with respect to framework 100, implementation 200, scenario 300 and implementation 400 as well as algorithm 500. Likewise, control logic 620 may be configured to perform operations for smart frequency boost for graphics-processing hardware 610 in manners similar to those described above with respect framework 100, implementation 200, scenario 300 and implementation 400 as well as algorithm 500. For instance, control logic 620 may monitor a queue of a plurality of graphics-related processes pending for execution by graphics-processing hardware 610. Control logic 620 may also determine whether an accumulation condition of the graphics-related processes in the queue is met based on the monitoring. Control logic 620 may further dynamically adjust at least one operating parameter of graphics-processing hardware 610 in response to a determination that the accumulation condition of the graphics-related processes in the queue is met.

In some implementations, graphics-processing hardware 610 may include one or more graphics processing units. Alternatively or additionally, graphics-processing hardware 610 may include a video decoder.

In some implementations, the accumulation condition of the graphics-related processes in the queue may refer to a condition in which a number of the graphics-related processes in the queue that graphics-processing hardware 610 is scheduled to simultaneously execute is equal to or greater than a predetermined number. In some implementations, the predetermined number may be two. In some implementations, the predetermined number may be varied, for example, according to scenarios or the types of hardware components.

In some implementations, the at least one operating parameter of graphics-processing hardware 610 may be a lower-bound frequency of graphics-processing hardware 610. Specifically, the lower-bound frequency of graphics-processing hardware 610 may define a lower bound of operating frequencies at which graphics-processing hardware 610 operates. In some implementations, control logic 620 may be further configured to perform DVFS to adjust a voltage, an operating frequency, or both, of graphics-processing hardware 610 according to varying process demands. In other words, a lower-bound frequency for performing DVFS may be made.

In some implementations, in dynamically adjusting the at least one operating parameter of graphics-processing hardware 610, control logic 620 may be configured to set the lower-bound frequency of graphics-processing hardware 610 to different frequencies according to variation of a number of the graphics-related processes in the queue that graphics-processing hardware 610 is scheduled to simultaneously execute. Alternatively, in dynamically adjusting the at least one operating parameter of graphics-processing hardware 610, control logic 620 may be configured to set the lower-bound frequency of graphics-processing hardware 610 to a fixed frequency.

In some implementations, at least one of the plurality of graphics-related processes may include one or more 3D fences.

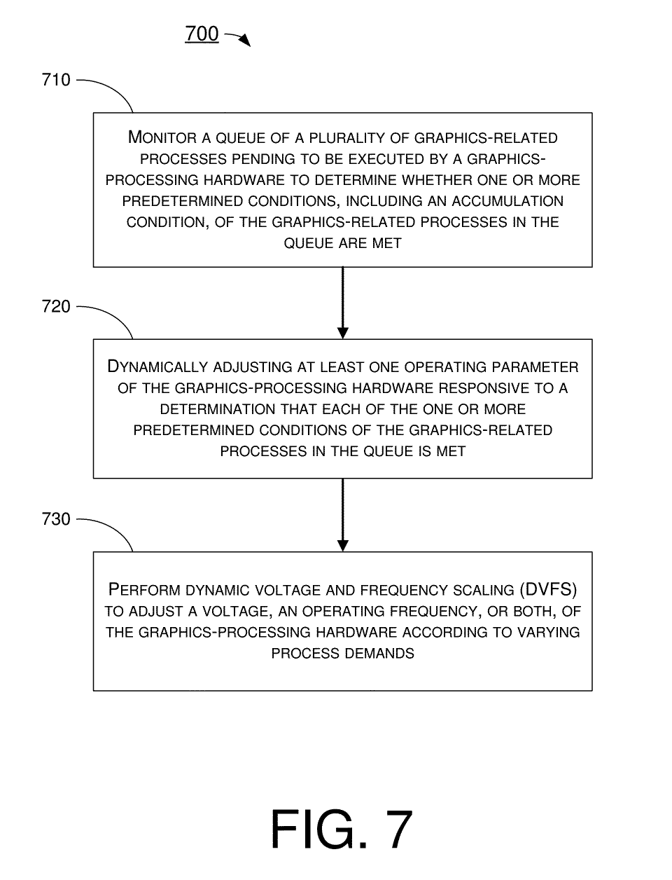

FIG. 7 illustrates an example process 700 in accordance with an implementation of the present disclosure. Process 700 may include one or more operations, actions, or functions as represented by one or more of blocks 710, 720 and 730. Although illustrated as discrete blocks, various blocks of process 700 may be divided into additional blocks, combined into fewer blocks, or eliminated, depending on the desired implementation. Process 700 may be implemented by apparatus 600. Solely for illustrative purpose and without limiting the scope of the present disclosure, process 700 is described below in the context of process 700 being performed by apparatus 600. Process 700 may begin at 710.

At 710, process 700 may involve portable apparatus 600 monitoring a queue of a plurality of graphics-related processes pending to be executed by a graphics-processing hardware to determine whether one or more predetermined conditions, including an accumulation condition of the graphics-related processes in the queue, are met. Process 700 may proceed from 710 to 720.

At 720, process 700 may involve apparatus 600 dynamically adjusting at least one operating parameter of the graphics-processing hardware in response to a determination that each of the one or more predetermined conditions, including the accumulation condition of the graphics-related processes in the queue, is met. Example process 700 may proceed from 720 to 730.

At 730, process 700 may involve apparatus 600 performing DVFS to adjust a voltage, an operating frequency, or both, of the graphics-processing hardware according to varying process demands.

In some implementations, the graphics-processing hardware may include one or more graphics processing units. Alternatively or additionally, the graphics-processing hardware may include a video decoder.

In some implementations, the accumulation condition of the graphics-related processes in the queue may refer to a condition in which a number of the graphics-related processes in the queue that the graphics-processing hardware is scheduled to simultaneously execute is equal to or greater than a predetermined number. In some implementations, the predetermined number may be two.

In some implementations, the at least one operating parameter of the graphics-processing hardware may include a lower-bound frequency of the graphics-processing hardware. Specifically, the lower-bound frequency of the graphics-processing hardware may define a lower bound of operating frequencies at which the graphics-processing hardware operates. In some implementations, in dynamically adjusting the at least one operating parameter of the graphics-processing hardware, process 700 may involve apparatus 600 setting the lower-bound frequency of the graphics-processing hardware to different frequencies according to variation of a number of the graphics-related processes in the queue that the graphics-processing hardware is scheduled to simultaneously execute. Alternatively or additionally, in dynamically adjusting the at least one operating parameter of the graphics-processing hardware, process 700 may involve apparatus 600 setting the lower-bound frequency of the graphics-processing hardware to a fixed frequency.

In some implementations, at least one of the plurality of graphics-related processes may include one or more 3D fences.

In some implementations, the plurality of graphics-related processes may include rendering one or more frames.

In some implementations, the plurality of graphics-related processes may include decoding one or more frames.

In some implementations, the one or more predetermined conditions may also include an overloading condition of the graphics-related processes in the queue. In some implementations, the overloading condition of the graphics-related processes in the queue may include a condition in which the graphics-related processes in the queue that the graphics-processing hardware is scheduled to simultaneously execute indicate a predicted loading greater than a threshold.

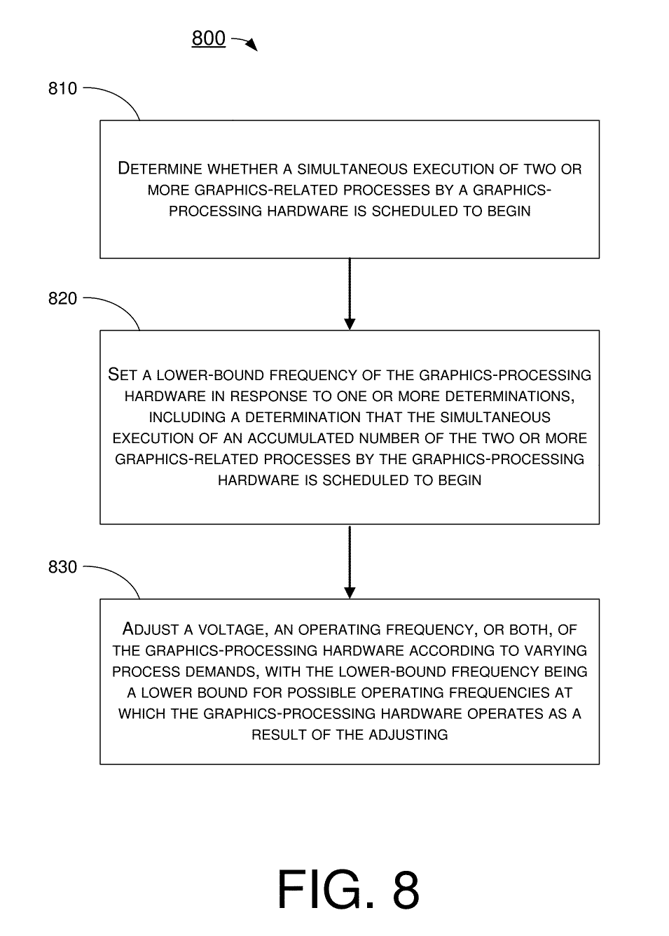

FIG. 8 illustrates an example process 800 in accordance with an implementation of the present disclosure. Process 800 may include one or more operations, actions, or functions as represented by one or more of blocks 810, 820 and 830. Although illustrated as discrete blocks, various blocks of process 800 may be divided into additional blocks, combined into fewer blocks, or eliminated, depending on the desired implementation. Process 800 may be implemented by apparatus 600. Solely for illustrative purpose and without limiting the scope of the present disclosure, process 800 is described below in the context of process 800 being performed by apparatus 600. Process 800 may begin at 810.

At 810, process 800 may involve apparatus 600 determining whether a simultaneous execution of two or more graphics-related processes by a graphics-processing hardware is scheduled to begin. Process 800 may proceed from 810 to 820.

At 820, process 800 may involve apparatus 600 setting a lower-bound frequency of the graphics-processing hardware in response to one or more determinations, including a determination that the simultaneous execution of an accumulated number of the two or more graphics-related processes by the graphics-processing hardware is scheduled to begin. The accumulated number may be greater than a predetermined number, for example, two or more. Process 800 may proceed from 820 to 830.

At 830, process 800 may involve apparatus 600 adjusting a voltage, an operating frequency, or both, of the graphics-processing hardware according to varying process demands. The lower-bound frequency may be a lower bound for possible operating frequencies at which the graphics-processing hardware operates as a result of the adjusting.

In some implementations, the two or more graphics-related processes may include rendering one or more frames.

In some implementations, the two or more graphics-related processes comprise decoding one or more frames.

In some implementations, the one or more determinations may also include a determination that the simultaneous execution of the graphics-related processes by the graphics-processing hardware indicates a predicted loading greater than a threshold.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
monitoring a queue of a plurality of graphics-related processes pending to be executed by a graphics-processing hardware to determine whether one or more predetermined conditions of the graphics-related processes in the queue are met, wherein the one or more predetermined conditions comprise an accumulation condition of the graphics-related processes in the queue; and
responsive to a determination that each of the one or more predetermined conditions of the graphics-related processes in the queue is met, dynamically adjusting at least one operating parameter of the graphics-processing hardware.

2. The method of claim 1, wherein the graphics-processing hardware comprises one or more graphics processing units.

3. The method of claim 1, wherein the graphics-processing hardware comprises a video decoder.

4. The method of claim 1, wherein the accumulation condition of the graphics-related processes in the queue comprises a condition in which a number of the graphics-related processes in the queue that the graphics-processing hardware is scheduled to simultaneously execute is equal to or greater than a predetermined number.

5. The method of claim 4, wherein the predetermined number is two.

6. The method of claim 1, wherein the at least one operating parameter of the graphics-processing hardware comprises a lower-bound frequency of the graphics-processing hardware, and wherein the lower-bound frequency of the graphics-processing hardware defines a lower bound of operating frequencies at which the graphics-processing hardware operates.

7. The method of claim 6, further comprising:
performing dynamic voltage and frequency scaling (DVFS) to adjust a voltage, an operating frequency, or both, of the graphics-processing hardware according to varying process demands.

8. The method of claim 6, wherein the dynamically adjusting of the at least one operating parameter of the graphics-processing hardware comprises setting the lower-bound frequency of the graphics-processing hardware to different frequencies according to variation of a number of the graphics-related processes in the queue that the graphics-processing hardware is scheduled to simultaneously execute.

9. The method of claim 6, wherein the dynamically adjusting of the at least one operating parameter of the graphics-processing hardware comprises setting the lower-bound frequency of the graphics-processing hardware to a fixed frequency.

10. The method of claim 1, wherein each of the plurality of graphics-related processes comprises one or more three-dimensional (3D) fences.

11. The method of claim 1, wherein the plurality of graphics-related processes comprise rendering one or more frames.

12. The method of claim 1, wherein the plurality of graphics-related processes comprise decoding one or more frames.

13. The method of claim 1, wherein the one or more predetermined conditions further comprise an overloading condition of the graphics-related processes in the queue.

14. The method of claim 13, wherein the overloading condition of the graphics-related processes in the queue comprises a condition in which the graphics-related processes in the queue that the graphics-processing hardware is scheduled to simultaneously execute indicate a predicted loading greater than a threshold.

15. A method, comprising:
determining whether a simultaneous execution of two or more graphics-related processes by a graphics-processing hardware is scheduled to begin;
setting a lower-bound frequency of the graphics-processing hardware in response to one or more determinations, wherein the one or more determinations comprise a determination that the simultaneous execution of an accumulated number of the two or more graphics-related processes by the graphics-processing hardware is scheduled to begin, the accumulated number equal to or greater than a predetermined number; and
adjusting a voltage, an operating frequency, or both, of the graphics-processing hardware according to varying process demands, wherein the lower-bound frequency is a lower bound for possible operating frequencies at which the graphics-processing hardware operates as a result of the adjusting.

16. The method of claim 15, wherein the two or more graphics-related processes comprise rendering one or more frames.

17. The method of claim 15, wherein the two or more graphics-related processes comprise decoding one or more frames.

18. The method of claim 15, wherein the one or more determinations further comprise a determination that the simultaneous execution of the graphics-related processes by the graphics-processing hardware indicates a predicted loading greater than a threshold.

19. An apparatus, comprising:
a graphics-processing hardware configured to execute one or more graphics-related processes; and
a control logic configured to perform operations comprising:
monitoring a queue of a plurality of graphics-related processes pending for execution by the graphics-processing hardware;
determining whether one or more predetermined conditions of the graphics-related processes in the queue are met based on the monitoring, wherein the one or more predetermined conditions comprise an accumulation condition of the graphics-related processes in the queue; and
dynamically adjusting at least one operating parameter of the graphics-processing hardware in response to a determination that each of the one or more predetermined conditions of the graphics-related processes in the queue is met.

20. The apparatus of claim 19, wherein the graphics-processing hardware comprises one or more graphics processing units.

21. The apparatus of claim 19, wherein the graphics-processing hardware comprises a video decoder.

22. The apparatus of claim 19, wherein the accumulation condition of the graphics-related processes in the queue comprises a condition in which a number of the graphics-related processes in the queue that the graphics-processing hardware is scheduled to simultaneously execute is equal to or greater than a predetermined number.

23. The apparatus of claim 22, wherein the predetermined number is two.

24. The apparatus of claim 19, wherein the at least one operating parameter of the graphics-processing hardware comprises a lower-bound frequency of the graphics-processing hardware, and wherein the lower-bound frequency of the graphics-processing hardware defines a lower bound of operating frequencies at which the graphics-processing hardware operates.

25. The apparatus of claim 24, wherein the control logic is further configured to perform dynamic voltage and frequency scaling (DVFS) to adjust a voltage, an operating frequency, or both, of the graphics-processing hardware according to varying process demands.

26. The apparatus of claim 24, wherein, in dynamically adjusting the at least one operating parameter of the graphics-processing hardware, the control logic is configured to set the lower-bound frequency of the graphics-processing hardware to different frequencies according to variation of a number of the graphics-related processes in the queue that the graphics-processing hardware is scheduled to simultaneously execute.

27. The apparatus of claim 24, wherein, in dynamically adjusting the at least one operating parameter of the graphics-processing hardware, the control logic is configured to set the lower-bound frequency of the graphics-processing hardware to a fixed frequency.

28. The apparatus of claim 19, wherein each of the plurality of graphics-related processes comprises one or more three-dimensional (3D) fences.

29. The apparatus of claim 19, wherein the plurality of graphics-related processes comprise rendering one or more frames.

30. The apparatus of claim 19, wherein the plurality of graphics-related processes comprise decoding one or more frames.

31. The apparatus of claim 19, wherein the one or more predetermined conditions further comprise an overloading condition of the graphics-related processes in the queue.

32. The apparatus of claim 31, wherein the overloading condition of the graphics-related processes in the queue comprises a condition in which the graphics-related processes in the queue that the graphics-processing hardware is scheduled to simultaneously execute indicate a predicted loading greater than a threshold.
